(19) United States
(12) Patent Application Publication
(10) Pub. No.: US 2005/0003179 A1
(43) Pub. Date: Jan. 6, 2005

(54) Ink jet recording material and recording method by use thereof

(75) Inventors: Junji Ito, Tokyo (JP); Toshihiko Iwasaki, Tokyo (JP); Kenzo Kasahara, Tokyo (JP); Yukako Taka, Tokyo (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Photo Imaging, Inc., Tokyo (JP)

(21) Appl. No.: 10/865,619

(22) Filed: Jun. 10, 2004

(30) Foreign Application Priority Data
Jun. 18, 2003 (JP) JP2003-173213

(51) Int. Cl. B41M 5/00; B32B 5/18

(52) U.S. Cl. 428/317.9; 428/195.1; 428/323; 428/331; 428/523; 347/105

(57) ABSTRACT

An ink jet recording material is disclosed, comprising a support having thereon a porous ink receiving layer containing inorganic particles, a polyvinyl alcohol exhibiting a degree of saponification of not less than 95 mol % and a compound represented by the following formula and having a molecular weight of not more than 200:

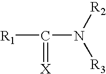

### FIELD OF THE INVENTION

The present invention relates to an ink jet recording material and in particular to an ink jet recording material exhibiting enhanced ink absorptivity, leading to no deterioration of quality such as cracking and achieving relatively high image density, and a recording method by the use thereof.

### BACKGROUND OF THE INVENTION

Recently, ink jet recording materials have been rapidly enhanced in image quality, which approaches photographic image quality. Specifically to achieve image quality equal to photographic image quality by ink jet recording, improvements in ink jet recording paper have proceeded. For example, a porous type recording paper comprising a highly flat support, provided thereon with a minute ink receiving layer comprising a pigment and a hydrophilic polymer, which exhibits high gloss, leads to clear color image formation and is superior in ink absorptivity and drying property, has become one of the recording materials closest to photographic image quality. The use of a non-water-absorbing support results in no occurrence of cockling (so-called cockles) after printing, as observed when using a water-absorbing support, thereby maintaining the highly flat surface and leading to high quality prints. Further, printed images using a water-soluble dye ink exhibit high clearness, leading to color prints exhibiting uniform surface gloss and equaling photographic image quality.

Specifically, ink jet recording materials having minute void sizes have rapidly become popular as ink jet recording paper for photographic use from the second half in the 1990's and have established their industrial status.

Characteristics required for a porous medium as an ink jet recording paper for photographic use include (1) a uniform surface and also a highly glossy surface, (2) rapid absorption of a received ink and (3) enhanced color formation. An ink jet recording paper exhibiting such characteristics include, one which is coated with a coating solution containing fine inorganic particles and a hydrophilic binder is commonly known, as described, for example, in JP-A No. 11-348409 (hereinafter, the term JP-A refers to unexamined Japanese Patent Application Publication) However, such a coating solution containing fine inorganic particles and a hydrophilic binder is so delicate and the porous film formed is so fragile, producing problems that handling during coating and drying or after drying often tends to result in deteriorated ink absorptivity or cracking.

There is known the use of urea or its derivatives, as a plasticizer for a binder, in the porous ink receiving layer constituting an ink jet recording paper. As disclosed in JP-A No. 7-314881, for example, there was proposed a recording sheet exhibiting superior image lasting quality and improved dye fixability, which was comprised of a substrate having thereon a porous ink receiving layer containing at least a compound selected from urea derivatives, semicarbazide derivatives, carbohydrazide derivatives and hydrazine derivatives. However, the foregoing patent document does not teach anything with respect to improvement of cracking by a urea derivative or its effect on ink absorptivity. There was also proposed an ink jet recording sheet provided with an ink receiving layer containing an aqueous resin and urea, thereby achieving superior ink absorptivity, drying property and storage stability and enhanced print density, as disclosed in JP-A No. 2000-118127. However, the foregoing disclosure, which teaches nothing with respect to effects relating to cracking, and is directed to improvement in an ink receiving layer mainly comprised of a polymer, teaches nothing with respect to a porous ink receiving layer containing fine inorganic particles. Further, as described in JP-A No. 2003-118127, there was proposed an ink jet recording material comprising a porous ink receiving layer containing at least one of sulfur-containing compounds, saccharides, carbamide compounds and dicyan-diamide type resin, and a binder, thereby leading to high gloss and improved ink absorptivity and image lasting quality (anti-room-fading and light stability). However, the foregoing proposals teach nothing with respect to the effect on cracking by the use of urea derivatives.

Whereas the use of polyvinyl alcohol having a saponification degree of 90 mol % or more is known to lead to improved ink absorptivity, coating an ink absorbing layer coating solution of such a composition tends to cause cracking in the drying stage. To overcome this problem, there was proposed a method in which an ink absorbing layer was formed, followed by coating with a hardener containing solution in the drying stage, as described in JP-A No. 2003-80837. However, this method requires an additional coating step and further results in new problems of coating qualities, caused by the hardener solution.

### SUMMARY OF THE INVENTION

According, it is an object of the present invention to provide an ink jet recording material exhibiting an enhanced ink absorptivity, leading to no deterioration of quality such as cracking and achieving relatively high image density, and a recording method using the same.

The foregoing object can be overcome by the following constitution.

Thus, in one aspect, the present invention is directed to an ink jet recording material comprising a support having thereon a porous ink receiving layer containing inorganic particles, a polyvinyl alcohol exhibiting a degree of saponification of not less than 95 mol % and a compound having a molecular weight of not more than 200 and represented by the following formula (1): 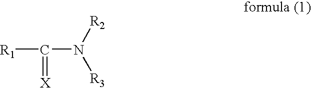
wherein R₁ is an alkyl group, alkenyl group, an aryl group, an acyl group, a heterocycle group, NR₄R₅ or OR₆; R₂ to R₆ are each the same as defined in R₁, provided that R₁ and R₂ or R₁ and R₃ may combine with each other to form a ring; X is an oxygen atom or NH.

In another aspect, the invention is directed to an ink jet recording method comprising printing on an ink jet recording material as described above using an ink an organic solvent content of not less than 20% by weight.

### DETAILED DESCRIPTION OF THE INVENTION

This invention concerns an ink jet recording material comprising on a support a porous ink receiving layer containing inorganic particles, a polyvinyl alcohol exhibiting a degree of saponification of 95 mol % or more and a compound having a molecular weight of not more than 200, which is represented by the foregoing formula(1) . A clear account cannot be given of the detailed mechanism of resistance to cracking and enhanced ink absorptivity achieved by the foregoing constituent feature but it is assumed to be as follows. With respect to the mechanism causing cracking, it is contemplated that cracking occurs with difficulty in a binder exhibiting high breaking strength or high breaking elongation and partial unevenness of moisture content partially occurs during the drying stage, producing a specific point such as a stress-concentrated point, where cracking starts as that point. It is assumed that the combined use of a compound of the foregoing formula (1), specifically urea or its derivatives, and a polyvinyl alcohol exhibiting a degree of saponification of at least 95 mol % raises the breaking elongation of the polyvinyl alcohol and prevents local unevenness in moisture content of a polyvinyl alcohol during the drying stage, thereby leading to enhanced resistance to cracking. However, other plasticizers or humectants often result in increased cracking, for which sufficient clarification has not as yet achieved. Effects achieved by the constitution of this invention are assumed to be a phenomenon occurring specifically only when the compound of the foregoing formula (1), specifically urea or its derivatives is used in combination with a polyvinyl alcohol exhibiting a degree of saponification of at least 95 mol %.

Although sufficient clarification has not been made with respect to the mechanism of enhancing ink absorptivity in the embodiment of this invention, its effect is marked when printing with an ink having a relatively high solvent content. There is assumed a mechanism such that an increased affinity between the ink and the ink receiving layer lowers the contact angle of an ink drop on the surface of the ink jet recording material or a viscous resistance between the ink drop and an ink receiving layer decreases, accelerating ink permeation.

In the ink jet recording material according to this invention, there is used a compound of the foregoing formula (1), having a molecular weight of 200 or less.

In the formula (1), R₁ represents a substituted or unsubstituted alkyl group (e.g., methyl ethyl, isopropyl, t-butyl, hexyl, dodecyl, cycloalkyl group), a substituted or unsubstituted alkenyl group (e.g., propenyl, butenyl, nonenyl), a substituted or unsubstituted aryl group (e.g., phenyl), a substituted or unsubstituted acyl group (e.g., acetyl, propionyl, butanoyl, hexanoyl, cyclohexanoyl, benzoyl, pyridinoyl), a substituted or unsubstituted heterocycle group (e.g., pyridyl, thiazolyl, oxathiazolyl, imidazolyl, furyl, pyrrolyl, pyrazinyl, pyrimidinyl, pyridazinyl, selenazolyl, sulfolanyl, piperidinyl, pyrazolyl, tetrazolyl) [preferably, a substituted or unsubstituted heteroaryl group (e.g., triazole group, imidazole group, pyridine group, furan group, thiophene group)], NR₄R₅ or OR₆; R₂ to R₆ are each the same as defined in the foregoing R₁, provided that R₁ and R₂ or R₁ and R₃ may combine with each other to form a ring; X is an oxygen atom or NH.

The compound of the formula (1) preferably contains no alcoholic hydroxyl group in terms of displaying the effects of this invention. The compound of the formula (1) has a molecular weight of 200 or less, in which the number of atoms other than a hydrogen atom is preferably 15 or less, and the compound is preferably water-soluble in terms of easiness of addition.

Specific examples of the compound of the formula (1) are shown below are by no means limited to these.

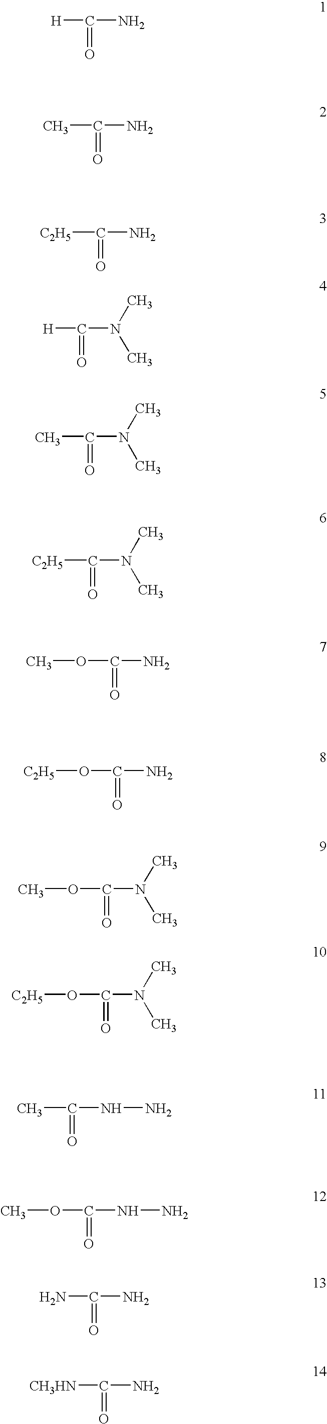

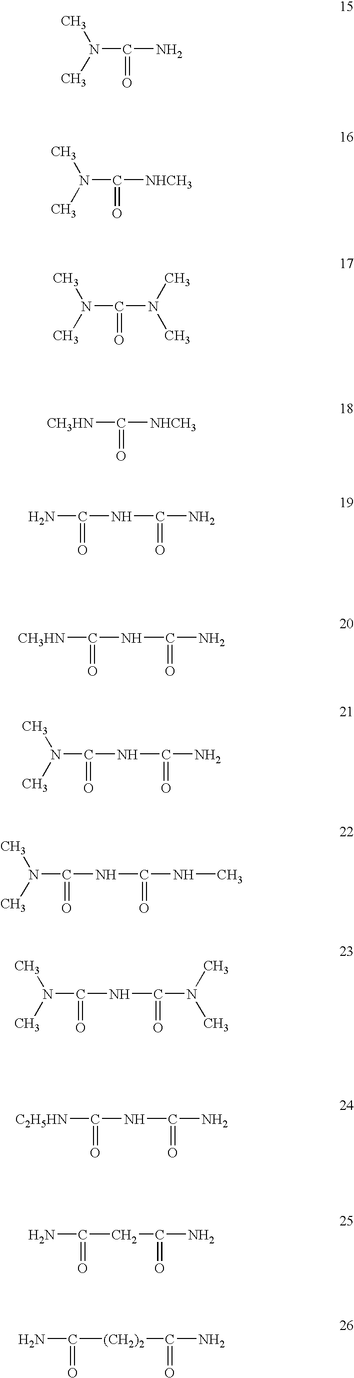

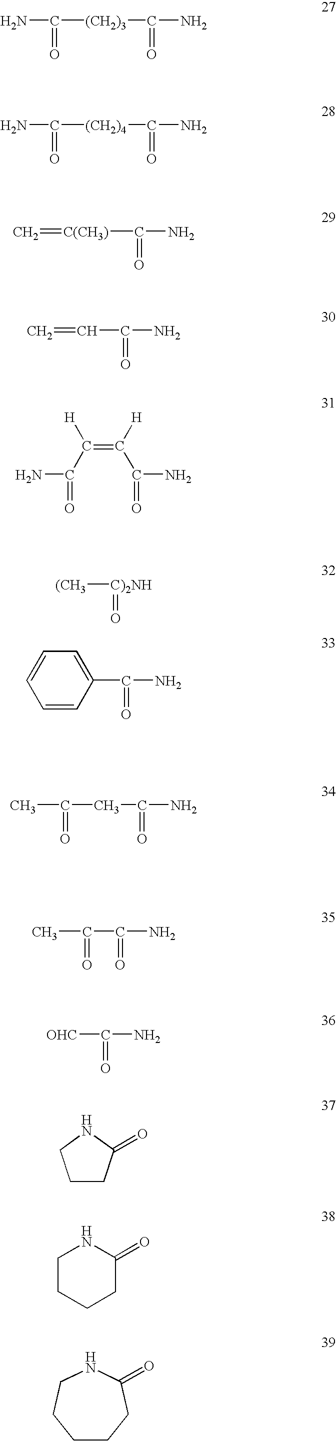

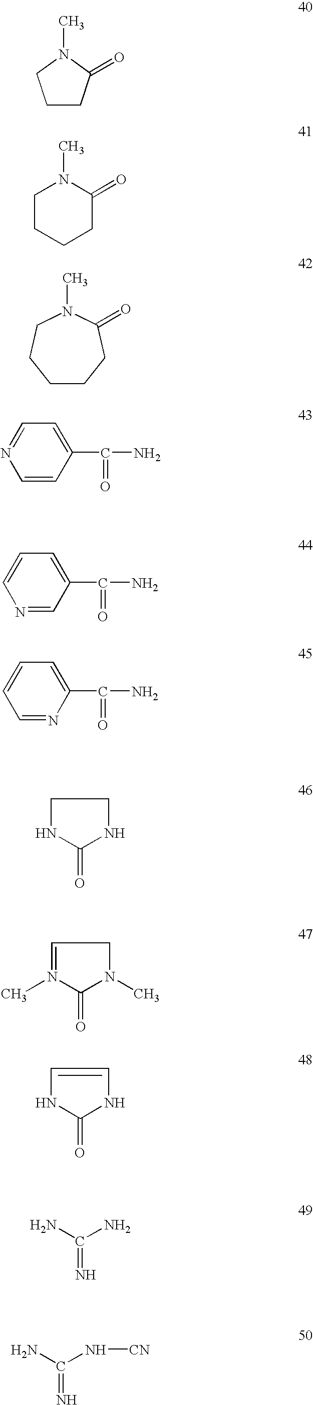

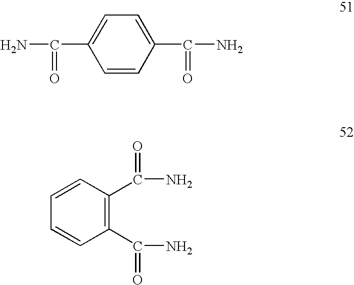

The compounds of formula (1) can be readily synthesized in accordance with commonly known methods and are also commercially available. Of the compounds of the formula (1), urea or urea derivatives are preferably used in the ink jet recoding material of this invention, and urea is more preferred.

In this invention, it is preferred that the porous ink receiving layer comprises at least two porous ink receiving layers, which are designated sublayers A and A′). It is further preferred that the sublayer (A) which is provided farther from the support than the sublayer (A′), has a content of the compound of formula (1) more than that of a porous ink receiving sublayer (A′) which is closer to the support than the sublayer (A). When at least three porous ink receiving sublayers are provided on the support, it is preferred that a sublayer farther from the support has a higher or equivalent content of the compound of formula (1).

The weight ratio (U/B) of a compound of the foregoing formula (1) to a polyvinyl alcohol (B) is preferably not less than 0.03, and not more than 0.5. When plural ink receiving layers are provided on the support, the foregoing weight ratio refers to a ratio of the total weight of a compound of the formula (1) per unit area to a total weight of a polyvinyl alcohol (B) per unit area. When the weight ratio of a compound of the foregoing formula (1) to a polyvinyl alcohol is less than 0.03, effects of this invention are difficult to be displayed and an weight ratio exceeding 0.5 results in deteriorations such as cracking, bleeding and staining.

Next, constituent elements of the ink jet recording material of this invention will be detailed.

Inorganic particles usable in this invention include white inorganic pigments such as soft calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomite, calcium silicate, magnesium silicate, synthetic amorphous silica, colloidal silica, alumina, colloidal alumina, pseudo-boehmite, aluminum hydroxide, lithopone, zeolite, and magnesium hydroxide. To obtain high-quality prints in the ink jet recording material, inorganic particles are preferably silica or alumina, alumina, pseudo-boehmite, colloidal silica and particulate silica prepared in the gas phase process (which is hereinafter also denoted simply as a gas phase process silica) are more preferred, and silica prepared in the gas phase process is still more preferred. The silica prepared in the gas phase process may be surface-modified with aluminum. The aluminum content of the aluminum-modified gas phase silica is preferably 0.05 to 5% based on silica.

Inorganic particles usable in the ink jet recording material of this invention preferably have an average primary particle size of not more than 10 nm, more preferably 3 to 10 nm, and still more preferably 5 to 10 nm. The foregoing average particle size of inorganic particles can be determined in the manner that when the section or the surface of the porous ink receiving layer is electron-microscopically observed, arbitrary 100 particles are measured with respect to particle size to determine an average (number-average) value thereof. The particle size of each particulate is represented in terms of a diameter of a circle having an area equal to the particulate projected area. Although the inorganic particulate may be present in the form of primary particles or secondary or higher-order aggregated particles in the porous ink receiving layer, the foregoing average primary particle size refers to one of independent particles present in the ink receiving layer when electron-microscopically observed.

The inorganic particles are contained in a coating solution of the porous ink receiving layer, preferably in an amount of 5 to 40%, and more preferably 7 to 30% by weight. The inorganic particles, which need to form a porous ink receiving layer exhibiting sufficient ink absorptivity with little film cracking, are contained in the porous ink receiving layer, preferably in a coating amount of not less than 10 g m², more preferably 10 to 55 g/m², and still more preferably 10 to 25 g/m².

Next, polyvinyl alcohol used as a hydrophilic binder will be described. There are generally known hydrophilic binders contained in a porous ink receiving layer including for example, gelatin, polyvinyl pyrrolidone, polyethylene oxide, polyacrylamide, and polyvinyl alcohol. Of these, a polyvinyl alcohol having a degree of saponification of 95 mol % or more is used in this invention.

Polyvinyl alcohol interacts with inorganic particles, exhibits high retentivity thereof and also a polymer exhibiting a relatively low moisture dependency, which is small in shrinkage stress in the drying stage and is superior in prevention of cracking occurred therein. Preferred polyvinyl alcohols usable in this invention include not only conventional polyvinyl alcohols obtained through hydrolysis of polyvinyl acetate but also modified polyvinyl alcohols such as a polyvinyl alcohol modified with a cation at the end position and an anion-modified polyvinyl alcohol.

A polyvinyl alcohol obtained through hydrolysis of polyvinyl acetate preferably has an average polymerization degree of 2500 to 5000 and one which has a degree of saponification of at least 95 mol % (preferably 95 to 99.8 mol %).

The foregoing cation-modified polyvinyl alcohol includes, for example, a polyvinyl alcohol containing a primary to tertiary amino group or quaternary amino group in the main chain or branch chain, which can be obtained by saponification of a copolymer formed of a cationic group-containing ethylenically unsaturated monomer and vinyl acetate. Examples of a cationic group-containing ethylenically unsaturated monomer include trimethyl-(2-acrylamido-2,2-dimethylethyl)ammonium chloride, trimethyl-(3-acrylamido-3,3-dimethylpropyl)ammonium chloride, N-vinylimidazole, N-methylvinylimidazole, N-(3-dimethylaminopropyl)methacrylamide, hydroxyethyltrimethylammonium chloride, and trimethyl-(3-methacrylamidopropyl)ammonium chloride. The cation-modified polyvinyl alcohol is formed of a cationic group-containing monomer, preferably in a content of 0.1 to 10 mol %, and more preferably 0.2 to 5 mol %, based on vinyl acetate.

Examples of an anion-modified polyvinyl alcohol include an anionic group-containing polyvinyl alcohol described in JP-A No. 1-206088 and a copolymer of vinyl alcohol and a water-solubilizing group-containing vinyl compound described in JP-A Nos. 61-237681 and 63-307979.

Examples of a nonion-modified polyvinyl alcohol include polyvinyl alcohol derivatives in which a polyalkylene oxide group is added to a part of a polyvinyl alcohol, as described in JP-A No. 8-25795; and a block copolymer of a hydrophobic group-containing vinyl compound and vinyl alcohol, as described in JP-A No. 8-25795.

There may be used a combination of two or more kinds of polyvinyl alcohols differing in polymerization degree or modification. Specifically, when a polyvinyl alcohol having an average polymerization degree of 2,500 or more, it is preferred that after added in an amount of 0.05 to 10 wt % (preferably 0.1 to 5.wt %), a polyvinyl alcohol having an average polymerization degree of 2,500 or more is further added.

In the ink jet recording material of this invention, the weight ratio (F/B) of inorganic particles (F) to polyvinyl alcohol contained in a porous ink receiving layer is preferably 5 to 30. A weight ratio of 5 or more enables to obtain a porous layer having a sufficient porosity, making it easy to obtain a sufficient void volume without clogging voids due to swelling of a hydrophilic binder, caused at the time of ink jet printing, thereby maintaining a high ink absorbing rate. A weight ratio of not more than 30 is difficult to cause cracking even when a porous ink receiving layer is coated at a relatively high thickness. The weight ratio (F/B) of inorganic particles to a hydrophilic binder is more preferably 5 to 20, and still more preferably 5 to 21.

To prevent bleeding of images during storage after recording, cationic polymers are employed in the ink jet recoding material of this invention. Cationic polymers include, for example, polyethyleneimine, polyallylamine, polyvinylamine, dicyandiamide polyalkylene polyamine condensation product, polyalkylene polyamine dicyandiamide ammonium salt condensation product, dicyandiamide formalin condensation product, epichlorohydrin.dialkylamine addition polymer, diallyldimethylammonium chloride polymer, diallyldimethylammonium chloride.SO₂ copolymer, polyvinylimidazole, vinylpyrrolidone.vinylimidazole copolymer, polyvinyl pyridine, polyamidine, chitosan, cationized starch, vinylbenzyltrimethylammonium chloride polymer, (2-methacryloyloxyethyl)trimethylammonium chloride polymer, and dimethylaminoethyl methacrylate polymer. There are further cited cationic polymers described in “Kagaku Kogyo Jiho” (Aug. 15, 25, 1998) and polymeric dye fixing agents described in “Kobunshi Yakuzay Nyumom” (Introduction to Polymeric Phamaceuticals, published by Sanyo Kasei Kogyo).

In the ink jet recording material, incorporation of polyvalent metal ions is preferred to improve water resistance or moisture resistance of images. Any polyvalent metal ion having di- or more valence is usable and preferred polyvalent metal ions include, for example, aluminum ion, zirconium ion, and titanium ion. These polyvalent metal ions may be incorporated in the form of a water-soluble or water-insoluble salt into the porous ink receiving layer.

Specific examples of an aluminum ion containing salt include aluminum fluoride, hexafluoroaluminic acid (e.g., potassium salt), aluminum chloride, basic aluminum chloride (e.g., polyaluminum chloride), tetrachloroaluminates (e.g., sodium salt), aluminum iodide, aluminates (e.g., sodium salt, potassium salt, calcium salt), aluminum chlorate, aluminum perchlorate, aluminum thiocyanate, aluminum sulfate, basic aluminum sulfate, potassium aluminum sulfate (alum), ammonium aluminum sulfate (ammonium alum), sodium aluminum sulfate, aluminum phosphate, aluminum nitrate, aluminum hydrogen phosphate, aluminum carbonate, poly(aluminum sulfate silicate), aluminum formate, aluminum acetate, aluminum lactate, aluminum oxalate, aluminum isopropiorate, aluminum butyrate, ethylacetate aluminum diisopropiorate, aluminum tris(acetylacetonate), aluminum tris(ethylacetoacetate9, and aluminum monoacetylacetonato-bis(ethylacetoacetonate). Of these, aluminum chloride, basic aluminum chloride, aluminum sulfate, basic aluminum sulfate and basic aluminum sulfate silicate are preferred and basic aluminum chloride and basic aluminum sulfate are more preferred.

Specific examples of zirconium ions include zirconium difluoride, zirconium trifluoride, zirconium tetrafluoride, hexafluorozirconate (e.g., sodium salt, potassium salt, ammonium salt), octafluorozirconate (e.g., lithium. salt), fluorinated zirconium, zirconium dichloride, zirconium trichloride, zirconium tetrachloride, hexachlorozirconate (e.g., sodium salt, potassium salt), chlorinated zirconium (zirconium chlorate), zirconium dibromide, zirconium tribromide, zirconium tetrabromide, zirconium bromate, zirconium triiodide, zirconium tetraiodide, zirconium peroxide, zirconium hydroxide, zirconium sulfide, zirconium sulfate, zirconium p-toluenesulfonate, zirconyl sulfate, sodium zirconyl sulfate, acidic zirconium sulfate trihydride, potassium zirconium sulfate, zirconium selenate, zirconium nitrate, zirconyl nitrate, zirconium phosphate, zirconyl carbonate, ammonium zirconium carbonate, zirconium acetate, ammonium zirconium acetate, zirconyl lactate, zirconyl citrate, zirconyl stearate, zirconyl phosphate, zirconyl oxalate, zirconium isopropiorate, zirconium butyrate, zirconium acetylacetonate, acetylacetone zirconium butyrate, zirconium stearate butyrate, zirconium acetate, bis(acetylacetonato)dichlorozirconium, and tris(acetylacetonato)chlorozirconium. Of the foregoing, zirconyl carbonate, ammonium zirconyl carbonate, zirconyl acetate, zirconyl nitrate, zirconyl chloride, zirconyl lactate and zirconyl citrate are preferred and ammonium zirconyl carbonate, zirconyl chloride and zirconyl chloride are specifically preferred.

The foregoing polyvalent metal ions may be used alone or in combination of two or more. A polyvalent metal ion containing compound may be added to a coating solution forming a porous ink receiving layer, or after coating a porous ink receiving layer, and specifically after drying the porous ink receiving layer, the compound may be supplied to the porous ink receiving layer by the over-coating method. In the former case when a polyvalent metal ion containing compound is added to the coating solution forming an ink receiving layer, there are applicable addition of solution in water or an in organic solvent or incorporation in the form of a particulate dispersion by a wet process pulverization such as a sand mill or by an emulsion dispersing method. When the porous ink receiving layer is composed of plural layers, the compound may be added to one of the layers, to at least two layers or to all of the layers. When added by the over-coating method after forming a porous ink receiving layer, it is preferred that after being homogeneously dissolved in a solvent, a polyvalent metal ion containing compound is supplied to the ink receiving layer. Polyvalent metal ions are used in an amount of 0.05 to 20 mmol, and preferably 0.1 to 10 mmol per m² of ink jet recording material.

Incorporation of a hardener for polyvinyl alcohol used as a hydrophilic binder forming a porous ink receiving layer is preferred in the ink jet recording material of this invention. Any compound capable of undergoing a hardening reaction with polyvinyl alcohol may be used as a hardeners in this invention. Boron compounds, specifically boric acid or its salts are preferred. Further, commonly known hardener compounds are also usable. Such compounds are generally those which contain a group capable of reacting with polyvinyl alcohol or promote a reaction between different groups contained in polyvinyl alcohol, which are optimally chosen in accordance with the kind of polyvinyl alcohol. Specific examples of a hardener include an epoxy type hardeners (e.g., diglycidyl ethyl ether, ethylene glycol diglycidyl ether, 1,4-butanediol glycidyl ether, 1,6-diglycidyl cyclohexane, N,N-diglycidyl-4-glycidyloxyaniline, sorbitol polyglycidyl ether, glycerol polyglycidyl ether), aldehyde type hardeners (e.g., formaldehyde, glyoxal), active halogen type hardeners (e.g., 2,4-dichloro-4-hydroxy-1,3,5-triazine), active vinyl type hardeners (e.g., 1,3,5-triacryloyl-hexahydro-s-triazine, bisvinylsulfonylmethl ether) and aluminum alum.

The foregoing boric acid and its salts refer to an oxyacid containing a boron atom as a central atom and its salts and specific examples thereof include orthoboric acid, diboric acid, metaboric acid, tetraboric acid, pentaboric acid, octaboric acid and their salts (or borates). Boric acid or its salts may be used alone or in a mixture thereof as a hardener. An aqueous mixture of boric acid and borax is specifically preferred. Aqueous boric acid and borax solutions can each be added only in a diluted solution but a mixture thereof can make it a concentrated solution, thereby making it possible to concentrate a coating solution. It has also an advantage that the pH of a solution added can be controlled relatively freely. The total amount of the foregoing hardener used is preferably 1 to 600 mg per g of polyvinyl alcohol.

In addition to the foregoing constituent elements, a variety of commonly known additives may be incorporated to the ink jet recording material of this invention. Examples thereof include organic latex particles of polystyrene, polyacrylic acid esters, polymethacrylic acid esters, polyacrylamides, polyethylene, polypropylene, polyvinyl chloride, polyvinilidene chloride, and their copolymers, urea resin and melamine resin; cationic surfactant, UV absorbers described in JP-A Nos. 57-74193, 57-87988 and 62-261476; anti-fading additives described in JP-A Nos. 57-74192, 57-87989, 60-72785, 61-146591, 1-95091 and 3-13376; brightening agents described in Jp-A Nos. 59-42993, 59-52689, 62-280069, 61-242871, and 4-219266; pH adjusting agents such as sulfuric acid, phosphoric acid, citric acid, sodium hydroxide, potassium hydroxide, and potassium carbonate; defoaming agents, thickeners, antistatic agents and matting agents.

Commonly known supports used in conventional ink jet recording materials are also usable in this invention. Water-absorbing supports may be used but non-water-absorbing supports are preferred.

Water absorbing supports usable in this invention include, for example, sheets and plates having conventional paper, cloth or wood. There are usable paper supports employing, as main raw material, wood pulp such as chemical pulp of LBK or NBK, machine pulp of GP, CGP, RMP, TMP, CTMP, CMP and PGW abd wastepaper pulp of DIP. Further, various fibrous materials such as synthetic pulp, synthetic fiber and inorganic fiber are also usable as raw material. The foregoing paper support may optionally contain various additives such as a sizing agent, pigment, reinforcing material, fixing agent, brightener, moisture reinforcing agent, and cationizing agent. Paper support can be prepared by mixing fibrous material such as wood pulp with various additives and using various paper machines such as a fourdrinier machine, cylinder machine, twin wire paper machine. Further, supports may optionally be subjected to a size press treatment, a coating treatment or a calendering treatment using starch or polyvinyl alcohol.

Non-water-absorbing supports usable in this invention include transparent supports and nontransparent (or opaque) supports. Transparent supports include films comprising polyester type resin, diacetate type resin, triacetate type resin, acryl type resin, polycarbonate type resin, polyvinyl chloride type resin, polyimide type resin, cellophane and celluloid. Of these, when used as an OHP, ones which are durable to radiation heat are preferred and polyethylene terephthalate is specifically preferred. Such a transparent support preferably has a thickness of 50 to 200 μm. Preferred nontransparent supports include resin coated paper (so-called RC paper) having a polyolefin resin coated layer containing white pigments on at least one side of base paper and so-called white PET which contains white pigments on a polyethylene terephthalate.

To strengthen adhesion between the support and a porous ink receiving layer, the support may be subjected to a corona discharge treatment or a subbing treatment prior to coating the porous ink receiving layer. Further, ink jet recording materials may not be necessarily colorless but may be a colored recording sheet.

In the ink jet recording material of this invention, it is preferred to employ a paper support laminated with polyethylene on both sides thereof, enabling to obtain high quality recording images close to photographic image quality at a low cost. Such a polyethylene-laminated paper support will be described below. Raw paper used in a paper support is made mainly from wood pulp, and optionally using a synthetic pulp such as polypropylene or synthetic fiber such as nylon or polyester. Any one of LBKP, LBSP, NBKP, NBSP, LDP, NDP, LUKP, and NUKP can be used as a wood pulp. It is preferred to use LBKP, NBSP, LBSP, NDP or LDP having a relatively high short fiber content, in a greater amount. The proportion of LBSP or LDP is preferably 10% to 70% by weight. Of the foregoing pulps, chemical pulps (e.g., sulfate pulp, sulfite pulp) having a low impurity content are preferably used and a pulp which has been bleached to enhance whiteness, is also useful.

There may optionally be incorporated to raw paper a sizing agent such as higher fatty acids or alkyl ketene dimmer, white pigments such as calcium carbonate, talc or titanium oxide, reinforcing agents such as starch, polyacrylamide or polyvinyl alcohol, brightening agents, moisture retainers such as polyethylene glycol, dispersing agents and softening agents such as quaternary ammonium.

S pulp used in paper-making preferably exhibits 200 to 500 ml of a freeness, as defined in CSF. With respect to a fiber length after being beated, the sum of 24 mesh residue weight % and 42 mesh residue weight %, as defined in JIS-P-8207 is preferably 30% to 70% by weight. The weight of raw paper is preferably 30 to 250 g, and more preferably 50 to 200 g. The raw paper thickness is preferably 40 to 250 μm. Raw paper may be subjected, in the paper making stage or thereafter, to a calendering treatment to provide a high smoothness. The raw paper density (as defined in JIS-P-8118) is generally 0.7 to 1.2 g/cm³. The raw paper stiffness (as defined in JIS-P-8143) is preferably 20 to 200 g. The raw paper surface may be coated with surface sizing agents. The surface sizing agents can employ sizing agents added to raw paper, as describe earlier. The pH of raw paper is preferably 5 to 9 when measured in accordance with the hot water extraction method defined in JIS-P-8113.

Polyethylene coated on the raw paper surface or back face is mainly comprised of a low density polyethylene (LDPE) and/or high density polyethylene (HDPE) and other LLDPE or polypropylene may partially be used.

A lutile type or anatase type titanium oxide which is broadly used in photographic print paper, is preferably incorporated into the polyethylene layer of the porous ink receiving layer side to improve opacity and whiteness. The titanium oxide content is usually 3% to 20%, and preferably 4% to 13% by weight, based on polyethylene.

Polyethylene coated paper can be used as glossy paper and also as silky surface or matted surface paper, as obtained in conventional photographic print paper, which is obtained by subjecting to a so-called embossing treatment when coated on the raw paper surface by melt extrusion. It is preferred to maintain the foregoing polyethylene coated paper at a moisture content of 3% to 10% by weight.

The ink jet recording material of this invention can be prepared by singly or simultaneously coating constituent layers including a porous ink receiving layer on the support, using a method selected from commonly known coating systems. Preferred coating systems include, for example, a roll coating method, a rod bar coating method, air-knife coating method, a spray coating method, a curtain coating method, a slide bead coating method using a hopper described in U.S. Pat. Nos. 2,761,419 and 2,761,791, and extrusion coat.

When simultaneously multiplayer-coated in the slide bead coating method, the viscosity of the respective coating solutions is preferably 5 to 100 mPa.s, and more preferably 10 to 50 mPa.s. When coated in the curtain coating method, the viscosity is preferably 5 to 1200 mPa.s, and more preferably 25 to 500 mPa.s. The viscosity of a coating solution at 15° C. is preferably at least 100 mPa.s, more preferably 3,000 to 30,000 mPa.s, and still more preferably 10,000 to 30,000 mPa.s.

Coating and drying are conducted preferably in such a manner that a coating solution is heated to a temperature of at 30° C. or more and coated, thereafter, the coated film is once cooled to a temperature of 1 to 15° C. and then dried preferably at a temperature of 10° C. or more, and more preferably at a wet-bulb temperature of 5 to 50° C. and a film surface temperature of 10 to 50° C. Cooling immediately after coating is conducted preferably in a horizontally setting system, in terms of uniformity of the formed film.

After over-coated and dried, the ink jet recording material prepared is preferably stocked in a roll form, or stocked preferably after being cut to a sheet form. When aged at 30° C. or higher over a given period of time, for example, one day to one month, the ink absorbing speed is further improved, resulting in reduced mottled appearance. The preferred aging condition is 1 to 30 days at 30 to 50° C.

### EXAMPLES

This invention is further described based on examples but embodiments of this invention are by no means limited to these. In examples, “%” represents % by weight, unless otherwise note.

### Example 1

### Preparation of Dispersion

Silica Dispersion D-1

To 110 lit. of an aqueous solution C-1 containing 12% cationic polymer P-1, 10% n-propanol and 2% ethanol (exhibiting a pH of 2.5 and further containing 2 g of defoamer SN-381, available from San-Nopco Co.) was added 400 lit. of a silica dispersion B-1 (exhibiting a pH of 2.6 and containing 0.5% ethanol) containing 25% gas-phase processed silica homogeneously dispersed and having an average primary particle size of 0.007 μm (Aerogel 300, available from Nippon Aerogel Co.), while stirring at a rate of 3,000 rpm under room temperature. Subsequently, 54 lit. of an aqueous solution A-1 composed of a mixture of boric acid and borax in a weight ratio of 1:1 (each 3% concentration) was gradually added thereto with stirring. Then, the mixture was dispersed under a pressure of 3 kN/cm² using a high pressure homogenizer (produced by Sanwa Kogyo Co., Ltd) and was made to a total amount of 630 lit. with water to obtain a substantially transparent silica dispersion D-1.

Silica Dispersion D-2

The foregoing dispersion B-1 of 400 lit. was added to 120 lit. of an aqueous solution C-2 containing 12% cationic polymer P-2, 10% n-propanol and 2% ethanol (exhibiting a pH of 2.5) with stirring at 3,000 rpm under room temperature, and subsequently, 52 lit. of the foregoing aqueous solution A-1 was gradually added with stirring. Then, the mixture was dispersed under a pressure of 3 kN/cm² using a high pressure homogenizer (produced by Sanwa Kogyo Co., Ltd) and was made to a total amount of 630 lit. with water to obtain a substantially transparent silica dispersion D-2.

Silica dispersion D-1 and D-2 were each filtered using a TCP-30 type filter having a filtering precision of 30 μm (product by Advantech Toyo Co.).

Cationic polymer P-1

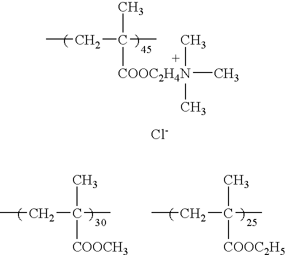

Cationic polymer P-2

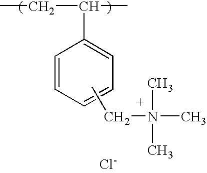

### Preparation of Recording Material

Coating Solution of Porous Ink Receiving Layer

Using the respective dispersions prepared above, the following additives were successively mixed to prepare a coating solutions of a porous ink receiving layer. Amounts are each represented per lit. of coating solution.

| 1st Layer coating solution: | | |
|---|---|---|
| Lowermost layer | | |
| Silica dispersion D-1 | 625 | ml |
| Aqueous 5% Polyvinyl alcohol (PVA135H, | 363 | ml |
| Kuraray, Av. polymerization degree: 3500, | | |
| Degree of saponification: 99.7%) | | |
| Ethanol | 8.5 | ml |
| Water to make | 1000 | ml |
| 2nd Layer coating solution | | |
| Silica dispersion D-1 | 625 | ml |
| Aqueous 5% Polyvinyl alcohol (PVA135H, | 363 | ml |
| Kuraray, Av. polymerization degree: 3500, | | |
| Degree of saponification: 99.7%) | | |
| Ethanol | 8 | ml |
| Water to make | 1000 | ml |
| 3rd Layer coating solution | | |
| Silica dispersion D-2 | 625 | ml |
| Aqueous 5% Polyvinyl alcohol (PVA135H, | 363 | ml |
| Kuraray, Av. polymerization degree: 3500, | | |
| Degree of saponification: 99.7%) | | |
| Ethanol | 3 | ml |
| Aqueous 10% urea* | 36 | ml |
| Water to make | 1000 | ml |
| (*exemplified compound 13) | | |
| 4th Layer coating solution | | |
| Silica dispersion D-2 | 625 | ml |
| Aqueous 5% Polyvinyl alcohol (PVA135H, | 363 | ml |
| Kuraray, Av. polymerization degree: 3500, | | |
| Degree of saponification: 99.7%) | | |
| Aqueous 4% cationic surfactant-4 | 3 | ml |
| Aqueous 25% saponin | 2 | ml |
| Ethanol | 3 | ml |
| Aqueous 10% urea | 36 | ml |
| Water to make | 1000 | ml |

Cationic surfactant-1

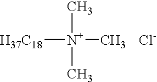

The thus prepared coating solutions were each filtered through a filter of 20 μm filtering precision (TCPD-30, available from Advantech.Toyo Co.) and further filtered through filter TCPD-10.

Recording Material 1

Using a slide hopper type coater, the foregoing coating solutions were simultaneously coated at 40° C. on a paper support laminated with polyethylene on both sides so as to form the wet thickness described below to prepare recording material 1.

Wet thickness
1st layer: 40 μm
2nd layer: 40 μm
3rd layer: 40 μm
4th layer: 40 μm

There was used a paper support in roll of 1.5 m width and 4000 m length, which was prepared as follows. Thus, on the surface of photographic raw paper having a moisture content of 8% and a weight of 170 g/m², polyethylene containing 6% anatase type titanium oxide was coated by melt extrusion coating at a thickness of 35 μm and polyethylene was coated on the back side by melt extrusion coating at a thickness of 40 μm. The surface side of the support was subjected to corona discharge and further thereon, a sublayer of polyvinyl alcohol (PVA235, available from Kuraray Co.) was coated at a coverage of 0.05 g per m² of ink jet recording material. The back side was also subjected to corona discharge and further thereon was coated a backing layer containing ca. 0.4 g of styrene-acrylic acid ester type latex binder exhibiting a glass transition point of ca. 80° C., 0.1 g of an antistatic (cationic polymer) and 0.1 g of silica matting agent of ca. 2 μm.

Porous ink receiving layer coating solutions were coated on the support and allowed to pass through a cooling zone maintained at 5° C. over a period of 15 sec to lower the film surface temperature to 13° C., followed by being dried in plural drying zones by blowing hot air of 20 to 40° C. for 6 to 7 min and wound up on a roll to obtain recording material 1. It was proved that the thus prepared recording material 1 exhibited a weight ratio (U/B) of 0.05 and a weight ratio (F/B) of 5.5, in which U designates urea or a compound of the foregoing formula (1), B designates polyvinyl alcohol and F designates particulate silica (or inorganic particles).

Recording Material 2

Recording material 2 was prepared similarly to the foregoing recording material 1, except that amounts of an aqueous 10% urea added to the 3rd and 4th layers were each changed to 18 ml. It was proved that recording material 2 exhibited a U/B of 0.05 and a F/B of 5.5.

Recording Material 3

Recording material 3 was prepared similarly to the foregoing recording material 1, except that amounts of an aqueous 10% urea added to the 3rd and 4th layers were each changed to 3.6 ml. It was proved that recording material 2 exhibited a U/B of 0.01 and a F/B of 5.5.

Recording Material 4

Recording material 4 was prepared similarly to the foregoing recording material 1, except that amounts of an aqueous 10% urea added to the 1st and 2nd layers were each changed to 18 ml and amounts of an aqueous 10% urea added to the 3rd and 4th layers were each changed to 18 ml. It was proved that recording material 2 exhibited a U/B of 0.10 and a F/B of 5.5.

Recording Material 5

Recording material 5 was prepared similarly to the foregoing recording material 1, except that amounts of aqueous 5% polyvinyl alcohol added to the 1st, 2nd, 3rd and 4th layers were each changed to 400 ml. It was proved that recording material 2 exhibited a U/B of 0.10 and a F/B of 5.0.

Recording Material 6

Recording material 6 was prepared similarly to the foregoing recording material 1, except that amounts of aqueous 5% polyvinyl alcohol added to the 1st, 2nd, 3rd and 4th layers were each changed to 444 ml. It was proved that recording material 2 exhibited a U/B of 0.10 and a F/B of 4.5.

Recording Materials 7 to 10

Recording materials 7 to 10 were each prepared similarly to the foregoing recording material 1, except that amounts of aqueous urea added to the 1st, 2nd, 3rd and 4th layers were each changed, as shown in Table 1.

Recording Material 11

Recording material 11 was prepared similarly to the foregoing recording material 1, except that an aqueous urea added to the 3rd and 4th layers were removed. It was proved that recording material 2 exhibited a F/B of 5.5.

Recording Material 12

Recording material 12 was prepared similarly to the foregoing recording material 1, except polyvinyl alcohol (PVA135H) added to the 1st, 2nd, 3rd and 4th layers was replaced by 625 ml of an aqueous 5% PVA235 (Kuraray, Av. polymerization degree: 3500, saponification degree: 88 mol %). It was proved that recording material 2 exhibited a U/B of 0.10 and a F/B of 5.5.

### Evaluation of Recording Material

Thus obtained recording materials 1 to 12 were each evaluated as follows.

Cracking resistance

The porous ink receiving layer surface of the respective recording material was observed over an area of 0.1 m² using a magnifier with respect to occurrence of cracking and evaluated based on the following criteria:
AA: No substantial cracking was observed,
A: Some minute cracks of less than 0.5 mm were observed,
B: Some coarse cracks of more than 0.5 mm were observed,
C: Cracks of more than 0.5 mm were overall observed. Ink absorptivity

Using ink jet printer PM900C (a product of Seiko-Epson Co.) and genuine green ink, solid green image printing was performed on the respective recording materials. Immediately after printing, the printed area was rubbed with a finger and visually observed with respect to disorder of images and evaluated with respect to ink absorptivity, based on the following criteria:
A: No image disorder was observed even when rubbed with a finger,
B: Images were slightly rubbed off and slightly stained when rubbed with a finger,
C: Images were rubbed off and markedly stained when rubbed with a finger.
   Densitometry

Using ink jet printer PM900C (a product of Seiko-Epson Co.) and genuine black ink, solid black image printing was performed on the respective recording materials. Reflection densities (D_{C}, D_{M} and D_{Y}) were measured using a reflection densitometer.

Results are shown in Table 1.

TABLE 1

| | Saponification | | | | | | | | | |
|---|---|---|---|---|---|---|---|---|---|---|
| Recording | Degree of | | | | | | | | | |
| Material | PVA*¹ | | Compound*³ | | Cracking | Ink | Image Density | | | |
| No. | (mol %) | U/B*² | (layer*⁴) | F/B*⁵ | Resistance | Absorptivity | D_{C} | D_{M} | D_{Y} | Remark |
| 1 | 99.7 | 0.10 | Urea | 5.5 | AA | A | 2.42 | 2.33 | 2.14 | Inv. |
| | | | (3rd, 4th layer) | | | | | | | |
| 2 | 99.7 | 0.05 | Urea | 5.5 | A | A | 2.41 | 2.29 | 2.13 | Inv. |
| | | | (3rd, 4th layer) | | | | | | | |
| 3 | 99.7 | 0.01 | Urea | 5.5 | B | A | 2.40 | 2.29 | 2.12 | Inv. |
| | | | (3rd, 4th layer) | | | | | | | |
| 4 | 99.7 | 0.10 | Urea | 5.5 | B | A | 2.41 | 2.32 | 2.15 | Inv. |
| | | | (all layers) | | | | | | | |
| 5 | 99.7 | 0.10 | Urea | 5.0 | A | A | 2.43 | 2.32 | 2.14 | Inv. |
| | | | (3rd, 4th layer) | | | | | | | |
| 6 | 99.7 | 0.10 | Urea | 4.5 | A | B | 2.41 | 2.30 | 2.13 | Inv. |
| | | | (3rd, 4th layer) | | | | | | | |
| 7 | 99.7 | 0.10 | 8 | 5.5 | A | A | 2.40 | 2.30 | 2.13 | Inv. |
| | | | (3rd, 4th layer) | | | | | | | |
| 8 | 99.7 | 0.10 | 21 | 5.5 | A | B | 2.39 | 2.29 | 2.12 | Inv. |
| | | | (3rd, 4th layer) | | | | | | | |
| 9 | 99.7 | 0.10 | 33 | 5.5 | A | A | 2.41 | 2.29 | 2.13 | Inv. |
| | | | (3rd, 4th layer) | | | | | | | |
| 10 | 99.7 | 0.10 | 52 | 5.5 | A | B | 2.40 | 2.31 | 2.13 | Inv. |
| | | | (3rd, 4th layer) | | | | | | | |
| 11 | 99.7 | — | — | 5.5 | C | B | 2.40 | 2.30 | 2.11 | Comp. |
| 12 | 88.0 | 0.10 | Urea | 5.5 | A | C | 2.33 | 2.16 | 2.03 | Comp. |
| | | | (3rd, 4th layer) | | | | | | | |

*¹PVA: polyvinyl alcohol
*²U/B: weight ratio of compound of formula (1) (U) to PVA (B)
*³Compound of formula (1)
*⁴Layer containing compound of formula (1)
*⁵F/B: weight ratio of particulate silica (F) to PVA (B)

As apparent from Table 1, it was proved that recording material of this invention, which had a porous ink receiving layer containing inorganic particles, polyvinyl alcohol having a degree of saponification of at 95 mol % or more and a compound of formula (1), led to improved resistance to cracking, superior ink absorptivity and enhanced image densities, as compared to comparative examples.

### Example 2

Using recording materials 1 and 11 of Example 1 and an ink set having a composition described below, ink jet printing was carried out and similarly to Example 1, evaluation was made with respect to ink absorptivity and image density. Results obtained are shown in Table 2.

Preparation of Ink Set

| Ink set A | | |
|---|---|---|
| Deep yellow ink Y1 | | |
| C.I. Acid Yellow 132 | 3.0 | wt % |
| Diethylene glycol | 10.0 | wt % |
| Glycerin | 10.0 | wt % |
| Triethylene glycol monomethyl ether | 5.0 | wt % |
| Surfactant (olfin E1010, Nishin Kagaku) | 1.0 | wt % |
| Deionized water | the rest | |
| Total organic solvent content | 25.0 | wt % |
| Light yellow ink Y2 | | |
| C.I. Acid Yellow 132 | 0.75 | wt % |
| Diethylene glycol | 10.0 | wt % |
| Glycerin | 10.0 | wt % |
| Triethylene glycol monomethyl ether | 10.0 | wt % |
| Surfactant (olfin E1010, Nishin Kagaku) | 1.0 | wt % |
| Deionized water | the rest | |
| Total organic solvent content | 30.0 | wt % |
| Deep magenta ink M1 | | |
| C.I. Acid Red 249 | 4.0 | wt % |
| Dipropylene glycol | 10.0 | wt % |
| Tetraethylene glycol | 10.0 | wt % |
| Triethylene glycol monobutyl ether | 10.0 | wt % |
| Surfactant (olfin E1010, Nishin Kagaku) | 1.0 | wt % |
| Deionized water | the rest | |
| Total organic solvent content | 30.0 | wt % |
| Light magenta ink M2 | | |
| C.I. Acid Red 249 | 1.0 | wt % |
| Diethylene glycol | 12.0 | wt % |
| Glycerin | 12.0 | wt % |
| Triethylene glycol monobutyl ether | 10.0 | wt % |
| Surfactant (olfin E1010, Nishin Kagaku) | 1.0 | wt % |
| Deionized water | the rest | |
| Total organic solvent content | 34.0 | wt % |
| Deep cyan ink C1 | | |
| C.I. Acid Blue 199 | 3.0 | wt % |
| Ethylene glycol | 10.0 | wt % |
| Glycerin | 10.0 | wt % |
| Dipropylene glycol monomethyl ether | 10.0 | wt % |
| Surfactant (olfin E1010, Nishin Kagaku) | 1.0 | wt % |
| Deionized water | the rest | |
| Total organic solvent content | 30.0 | wt % |
| Light cyan ink C2 | | |
| C.I. Acid Blue 199 | 1.0 | wt % |
| Dipropylene glycol | 5.0 | wt % |
| Glycerin | 10.0 | wt % |
| Dipropylene glycol monomethyl ether | 10.0 | wt % |
| Surfactant (olfin E1010, Nishin Kagaku) | 1.0 | wt % |
| Deionized water | the rest | |
| Total organic solvent content | 25.0 | wt % |
| Deep black ink K1 | | |
| Basacid Black X34 | 30.0 | wt % |
| Ethylene glycol | 7.0 | wt % |
| Diethylene glycol | 7.0 | wt % |
| Glycerin | 7.0 | wt % |
| Diethylene glycol monomethyl ether | 3.0 | wt % |
| Surfactant (olfin E1010, Nishin Kagaku) | 1.0 | wt % |
| Deionized water | the rest | |
| Total organic solvent content | 24.0 | wt % |
| Light black ink K2 | | |
| Basacid Black X34 | 9.0 | wt % |
| Ethylene glycol | 7.0 | wt % |
| Propylene glycol | 7.0 | wt % |
| Glycerin | 7.0 | wt % |
| Triethylene glycol monobutyl ether | 3.0 | wt % |
| Surfactant (olfin E1010, Nishin Kagaku) | 1.0 | wt % |
| Deionized water | the rest | |
| Total organic solvent content | 24.0 | wt % |
| Ink set B | | |
| Deep yellow ink Y3 | | |
| C.I. Acid Yellow 132 | 3.0 | wt % |
| Diethylene glycol | 7.5 | wt % |
| Glycerin | 7.5 | wt % |
| Triethylene glycol monomethyl ether | 2.5 | wt % |
| Surfactant (olfin E1010, Nishin Kagaku) | 1.0 | wt % |
| Deionized water | the rest | |
| Total organic solvent content | 17.5 | wt % |
| Light yellow ink Y4 | | |
| C.I. Acid Yellow 132 | 0.75 | wt % |
| Diethylene glycol | 6.0 | wt % |
| Glycerin | 6.0 | wt % |
| Triethylene glycol monomethyl ether | 6.0 | wt % |
| Surfactant (olfin E1010, Nishin Kagaku) | 1.0 | wt % |
| Deionized water | the rest | |
| Total organic solvent content | 18.0 | wt % |
| Deep magenta ink M3 | | |
| C.I. Acid Red 249 | 4.0 | wt % |
| Dipropylene glycol | 6.0 | wt % |
| Tetraethylene glycol | 6.0 | wt % |
| Triethylene glycol monobutyl ether | 6.0 | wt % |
| Surfactant (olfin E1010, Nishin Kagaku) | 1.0 | wt % |
| Deionized water | the rest | |
| Total organic solvent content | 18.0 | wt % |
| Light magenta ink M4 | | |
| C.I. Acid Red 249 | 1.0 | wt % |
| Diethylene glycol | 6.0 | wt % |
| Glycerin | 6.0 | wt % |
| Triethylene glycol monobutyl ether | 5.0 | wt % |
| Surfactant (olfin E1010, Nishin Kagaku) | 1.0 | wt % |
| Deionized water | the rest | |
| Total organic solvent content | 17.0 | wt % |
| Deep cyan ink C3 | | |
| C.I. Acid Blue 199 | 3.0 | wt % |
| Ethylene glycol | 6.0 | wt % |
| Glycerin | 6.0 | wt % |
| Dipropylene glycol monomethyl ether | 6.0 | wt % |
| Surfactant (olfin E1010, Nishin Kagaku) | 1.0 | wt % |
| Deionized water | the rest | |
| Total organic solvent content | 18.0 | wt % |
| Light cyan ink C4 | | |
| C.I. Acid Blue 199 | 1.0 | wt % |
| Dipropylene glycol | 2.5 | wt % |
| Glycerin | 7.5 | wt % |
| Dipropylene glycol monomethyl ether | 7.5 | wt % |
| Surfactant (olfin E1010, Nishin Kagaku) | 1.0 | wt % |
| Deionized water | the rest | |
| Total organic solvent content | 17.5 | wt % |
| Deep black ink K3 | | |
| Basacid Black X34 | 30.0 | wt % |
| Ethylene glycol | 5.0 | wt % |
| Diethylene glycol | 5.0 | wt % |
| Glycerin | 5.0 | wt % |
| Diethylene glycol monomethyl ether | 3.0 | wt % |
| Surfactant (olfin E1010, Nishin Kagaku) | 1.0 | wt % |
| Deionized water | the rest | |
| Total organic solvent content | 18.0 | wt % |
| Light black ink K4 | | |
| Basacid Black X34 | 9.0 | wt % |
| Ethylene glycol | 4.0 | wt % |
| Propylene glycol | 4.0 | wt % |
| Glycerin | 7.0 | wt % |
| Diethylene glycol monobutyl ether | 4.0 | wt % |
| Surfactant (olfin E1010, Nishin Kagaku) | 1.0 | wt % |
| Deionized water | the rest | |
| Total organic solvent content | 19.0 | wt % |

Charging each of the foregoing ink sets into an on-demand type ink jet printer provided with a piezo type head having 23 μm of a nozzle diameter, 12 kHz of a driving frequency, a nozzle number of 128 per one color, a nozzle density of 90 dpi (dpi refers to the number of dots per 2.54 cm) and exhibiting a maximum recording density of 720×720 dpi, solid images of the respective colors were printed on recording materials 1 and 11 of Example 1.

Evaluation of Ink Absorptivity

Of the respective color images of each of the recording materials, the printed area, immediately after printing, was rubbed with a finger and visually observed with respect to disorder of images, and evaluated with respect to ink absorptivity, based on the following criteria:
A: no image disorder was observed when rubbed with a finger,
B: images were slightly rubbed off and stained when rubbed with a finger,
C: images were rubbed off and markedly stained when rubbed with a finger.
   Evaluation was represented by an average value of the respective colors.
   Image Density

Using a reflection densitometer, cyan, magenta and yellow solid images were measured with respect to their reflection densities (D_{C}, D_{M}, D_{Y})

Results obtained are shown in Table 2.

TABLE 2

| Recording | Ink | Ink | Image density | | | |
|---|---|---|---|---|---|---|
| Material No. | Set No. | Absorptivity | D_{C} | D_{M} | D_{Y} | Remark |
| 1 | A | A | 2.44 | 2.39 | 2.16 | Inv. |
| 1 | B | A | 2.38 | 2.31 | 2.11 | Inv. |
| 11 | A | B | 2.33 | 2.24 | 2.07 | Comp. |
| 11 | B | B | 2.31 | 2.21 | 2.05 | Comp. |

As apparent from Table 2, it was proved that using an ink having a total organic solvent content of 20 wt % or more, printing on a recording material recording provided with a porous ink receiving layer containing inorganic particles, polyvinyl alcohol having a degree of saponification of at 95 mol % or more and a compound of formula (1) led to superior ink absorptivity and an enhanced image density, compared to comparative samples.

1. An ink jet recording material comprising a support provided thereon with a porous ink receiving layer containing inorganic particles, a polyvinyl alcohol exhibiting a degree of saponification of not less than 95 mol % and a compound represented by the following formula (1) and having a molecular weight of not more than 200: 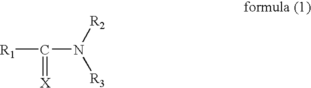
wherein R₁ is an alkyl group, alkenyl group, an aryl group, an acyl group, a heterocyclic group, NR₄R₅ or OR₆; R₂ to R₆ are each the same as defined in R₁, provided that R₁ and R₂ or R₁ and R₃ may combine with each other to form a ring; X is an oxygen atom or NH.

2. The ink jet recording material of claim 1, wherein the compound represented by formula (1) is urea or a urea derivative.

3. The ink jet recording material of claim 1, wherein the compound represented by formula (1) is urea.

4. The ink jet recording material of claim 1, wherein a ratio by weight of the compound represented by formula (1) to the polyvinyl alcohol is 0.03 to 0.5.

5. The ink jet recording material of claim 1, wherein the porous ink receiving layer comprises at least two layers (A and A′); the layer (A) which is provided farther from the support than the layer (A′) contains the compound of formula (1) in an amount more than the layer (A′).

6. The ink jet recording material of claim 1, wherein the polyvinyl alcohol has an average polymerization degree of 2500 to 5000.

7. The ink jet recording material of claim 1, wherein a ratio by weight of the inorganic particles to the polyvinyl alcohol is 5 to 30.

8. The ink jet recording material of claim 1, wherein the porous ink receiving layer contains a boric acid or its salt.

9. The ink jet recording material of claim 1, wherein the inorganic particles have an average primary particle size of not more than 10 nm.

10. The ink jet recording material of claim 1, wherein the inorganic particles are a silica.

11. The ink jet recording material of claim 10, wherein the silica is a gas phase silica.

12. An ink jet recording method comprising:
printing on an ink jet recording material as claimed in claim 1 using a ink having an organic solvent content of not less thank 20% by weight.
